(19) United States
(12) Patent Application Publication
(10) Pub. No.: US 2020/0188901 A1
(43) Pub. Date: Jun. 18, 2020

(54) DEVICE FOR DETECTING A RISK OF HYDROGEN EMBRITTLEMENT OF A METAL TECHNICAL FIELD

(71) Applicant: IFP Energies nouvelles, RUEIL-MALMAISON CEDEX (FR)

(72) Inventors: Jean KITTEL, RUEIL-MALMAISON CEDEX (FR); Alexandre BONNEAU, RUEIL-MALMAISON CEDEX (FR)

(73) Assignee: IFP Energies nouvelles

(21) Appl. No.: 16/708,755

(22) Filed: Dec. 10, 2019

(30) Foreign Application Priority Data
Dec. 13, 2018 (FR) 18/72.831

(51) Int. Cl. B01L 1/02

(52) U.S. Cl. CPC B01L 1/025; B01L 2300/12; B01L 2300/0663

(57) ABSTRACT

The present invention relates to a device for detecting a risk of hydrogen embrittlement of a metal, the device being intended to be placed in a hydrogenating environment. The device according to the invention comprises at least: (a) a pressure measuring means, (b) a closed chamber delimited by walls formed from the metal, (c) at least one body formed from a material that is non-porous and inert with respect to hydrogen, placed inside the chamber, the volume of the body or bodies representing at least 50% of the interior volume of the chamber.

### TECHNICAL FIELD

The present invention relates to the field of the detection of a risk of hydrogen embrittlement (HE) of a metal such as steel, which risk may notably arise in hydrogenating environments such as oil refining, oil production, the transport of petroleum products or else the treatment of biogas derived from the breakdown of organic matter.

More particularly, the present invention relates to a device for detecting a risk of hydrogen embrittlement of a metal. Furthermore, the present invention relates to a system comprising at least one such device and a piece of industrial equipment to be monitored, at least one part of which is made from this metal, and to a method for monitoring such a piece of industrial equipment subjected to a hydrogenating environment using such a device.

Hydrogen embrittlement is a relatively frequent phenomenon involved in damage to industrial equipment made of metallic materials, with consequences that can sometimes be disastrous. The physical origin of this phenomenon stems from the ease with which hydrogen can diffuse through most metals, because of its very small size (it is the smallest of the atoms). When the harsh environments to which the metals are subjected contain hydrogen, either in the form of gas molecules or as a component of molecules liable to react with the surface of the metal, the hydrogen can then possibly penetrate the metal, notably steel.

Once inside the steel, the hydrogen can then diffuse fairly easily, and possibly accumulate in favourable metallurgical zones, such as crystal-structure defects (dislocations, gaps, precipitates), grain boundaries, inclusions.

This buildup of hydrogen leads to degradation of the mechanical properties of the metal.

If the metal is subjected to stresses (external or residual) and the mechanical strength associated with the hydrogen drops below the applied stresses, localized cracking may occur. The stresses in question may have different origins: localized residual stresses associated with metallographic defects, stresses originating from shaping steps, equipment in-service stresses (weights, internal pressures, etc.). Then, with the buildup of gaseous hydrogen under high pressure in the cavities formed, the crack may begin to spread.

This type of cracking represents a significant industrial concern in so far as it is a phenomenon that is generally sudden, without obvious warning signs, and which may lead to complete breakage of the equipment. There is therefore a true benefit in having the use of a sensor that makes it possible to anticipate the onset of this risk of breakage.

There are a wide diversity of environments affected by HE, such as, for example, gaseous environments containing hydrogen, corrosive aqueous environments in which a reduction reaction involving a hydrogenated compound (such as water or such as H+ ions in an acid medium) occurs.

### PRIOR ART

There are two broad families of method predominantly used to evaluate the risks of hydrogen embrittlement in industrial equipment:
periodic inspection using nondestructive test equipment
the use of sensors aimed at evaluating the hydrogen flux passing through the metal.

Periodic inspection has the main goal of detecting the presence of any cracks that might be present, with a detection threshold that is as fine as possible, and/or of monitoring how cracks already detected in a previous inspection are evolving over time. However, this type of method has a relatively high level of risk associated, on the one hand, with the generally rapid nature of the spread of cracks once they have started, and, on the other hand, with the localized nature of the cracks, which means that there is a high probability that an inspection, that rarely covers the entirety of the equipment, may not detect the said cracks. Therefore, a HE-specific inspection is often restricted to equipment for which the consequences of cracks are not too serious, for example equipment operating under moderate pressure with fluids that are not overly hazardous.

The use of specific sensors allows more regular monitoring.

In terms of hydrogen embrittlement, the parameter most often used is the hydrogen flux passing through a metallic membrane. Specifically, as indicated above, hydrogen embrittlement of metals stems from the ingress of hydrogen from the harsh environment towards the interior of the steel. This penetrating flux proves to be relatively easy to measure using through-membrane permeation devices, by direct application of Fick's laws of diffusion. The sensors used generally consist in a steel membrane, one of the faces of which is exposed to the hydrogenating environment, while the other face is kept under conditions that allow the hydrogen to re-emerge with a device for measuring this exiting flux. In the textbook case of hydrogen diffusing without interacting with the metal (diffusion purely through the gaps), measuring the steady-state flux makes it possible to estimate the hydrogen concentration in the metal at the sensor inlet face. There are several types of device for measuring the hydrogen flux leaving the membrane. Those most often mentioned in scientific literature are electrochemical devices for which the hydrogen-outlet metallic face is brought into contact with a solution of electrolyte and kept at a potential at which the oxidation of hydrogen atoms occurs spontaneously and generates an electric current that can be measured by a device of the ammeter type. This type of device is not very suitable for applications involving monitoring equipment in service, because of the complexity of implementing it, which requires the use of a measurement chamber filled with a solution of electrolyte and equipped with an electrochemical measurement system.

Also known (U.S. Pat. No. 4,416,996A) are devices employing a measurement of the volume of hydrogen in a closed and partially liquid-filled cavity. The change in the volume thus gives a direct measurement of the hydrogen flux leaving the membrane, and this flux can then be used to estimate the risk of hydrogen embrittlement.

Evaluating the rate of corrosion of the internal metal wall is another often-cited application for the aforementioned devices that measure a flux of hydrogen through a metal wall. The principle behind these measurements relies on the link between the quantity of hydrogen entering the steel and the rate of corrosion. This link is a relatively direct one, for example in the case of corrosion in an aqueous acid environment, in which the cathode reaction is the reduction of a proton, yielding a hydrogen atom which can then enter the metal and diffuse. Such methods for monitoring corrosion are also mentioned in U.S. Pat. No. 6,058,765A and US2013236975A.

Certain limits can be identified for the prior art devices cited hereinabove. First, the parameter measured is always a flux of hydrogen through a metallic wall. A correlation between the magnitude of this flux and the risk of hydrogen embrittlement, or the rate of corrosion of the internal wall, is then proposed. Now, this link is far from being a direct link. Indeed those skilled in the art know that hydrogen embrittlement leading to internal cracking (the phenomenon referred to as “blistering” or “Hydrogen Induced Cracking”, or HIC for short) is strongly linked to the amount of hydrogen absorbed into the metal and to its chemical activity in the metal. The onset of cracking requires the absorbed hydrogen to reach a sufficiently high concentration. While the magnitude of the hydrogen flux is one of the parameters that is easiest to measure, this does not make it the most relevant parameter: indeed it indicates the rate at which hydrogen is entering the metal, but does nothing to indicate the limit value (absorbed-hydrogen activity or concentration) that will be reached in the steady-state. This steady-state hydrogen concentration or activity value is denoted Ce. It corresponds to an internal pressure of hydrogen (through the application of Sieverts' law), which is referred to in the remainder of the text as the equilibrium pressure or Pe. Now, it is very much the exceeding of an internal hydrogen concentration above a given threshold (referred to as the threshold concentration Cs or threshold pressure Ps, depending on whether it is concentration or activity values, or pressure values, themselves interconnected by Sieverts' law, that are being used) which dictates whether there will or will not be cracking. This equilibrium concentration (Ce) value can be estimated using flux measurements, but only fairly approximately, and by making numerous simplifying assumptions regarding the diffusion mode, the diffusion coefficient, and the wall thickness, by considering that the equilibrium concentration (Ce) is equal to the concentration of hydrogen absorbed into the metal at the inlet face (C0), calculated from the flux measurements.

Devices that implement pressure measurement, but for estimating the hydrogen flux, are also known. In that case, the hydrogen outlet face opens into a fluidtight chamber in which the pressure is measured, and the hydrogen flux can therefore be deduced from the rate of pressure increase. This type of sensor is generally equipped with a purge system so as to regularly discharge the hydrogen that has built up in the sensor and maintain a maximum hydrogen gradient across the membrane. This principle is described in U.S. Pat. No. 6,537,824B. As highlighted in that document, this type of sensor may have very long response times, of the order of one month, which means that it cannot be used to monitor industrial equipment in real time.

Another known document is patent application WO 2017/080780, which describes a sensor and a method for measuring the risk of hydrogen embrittlement of a metal relying on measuring the pressure in a cavity formed in this metal and directly interpreting this pressure measurement in order to estimate a risk of embrittlement, by comparing a measured pressure with a predefined threshold pressure beyond which hydrogen induced cracking may occur. In order to achieve reasonable response times in service, that document teaches the use of thin wall thicknesses. Indeed, because the flux of hydrogen diffusing through steel is inversely proportional to the thickness of metal to be crossed, reducing the thickness makes it possible to increase the flux, and therefore obtain a more rapid rise in pressure in the cavity.

However, that design has a major downside, namely of reducing the mechanical strength of the hollow metallic body. There is in fact a risk of reaching a pressure at which the metallic body bursts. It is important to note that the burst pressure must not be confused with the threshold pressure beyond which hydrogen embrittlement induced cracking may occur in a metal. Specifically, the burst pressure defines the pressure needed to cause pressure equipment to burst. It is therefore dependent on mechanical properties and geometric characteristics of the system, and is calculated using burst mechanics. The hydrogen threshold pressure indicates a threshold concentration of hydrogen dissolved in a metal that is high enough to lead to internal decohesions on a crystallography scale. It is dependent on the metallography properties which fall within the scope of the physics of the solid.

The present invention aims to overcome these drawbacks. More specifically, the present invention relates to a device for detecting a risk of hydrogen embrittlement of a metal, that has both a response time and a mechanical strength that are acceptable in service.

### SUMMARY OF THE INVENTION

The present invention relates to a device for detecting a risk of hydrogen embrittlement of a metal, the said device being intended to be placed in a hydrogenating environment, the said device comprising at least:
a pressure measuring means,
a closed chamber, the said chamber being delimited by walls formed from the said metal, the said chamber comprising an opening to communicate with the said pressure measuring means

In addition, the device according to the invention comprises at least one body formed from a material that is non-porous and inert with respect to hydrogen and placed inside the said chamber, the volume of the said at least one body representing at least 50% of the interior volume of the said chamber.

According to one embodiment of the invention, the said volume of the said at least one body may represent at least 75% of the interior volume of the said chamber.

According to one embodiment of the invention, the said material of the said body may be a non-porous ceramic or a non-porous glass.

According to one embodiment of the invention, the said device may further comprise means for transmitting the measurements taken by means of the said pressure measuring means and/or means for processing the measurements taken by means of the said pressure measuring means.

According to one embodiment of the invention, the said device may further comprise a means for raising an alert when a pressure higher than a maximum acceptable service pressure is measured by means of the said pressure measuring means.

According to one implementation of the invention, the said walls may be made of steel.

The invention also relates to a system comprising at least one piece of equipment and at least one device as described hereinabove, the said equipment comprising at least one wall made from the said metal, the said chamber of the said device being formed in at least part of the said wall in the said equipment.

According to one embodiment of the invention, the said system may comprise at least one piece of equipment and at least one device as described hereinabove, the said equipment comprising at least one element formed from the said metal, the said device being separate from the said equipment.

According to one embodiment of the invention, the said equipment may be a pipeline.

According to one embodiment of the invention, the said equipment may be a chemical reactor.

The invention also relates to a method for monitoring, over the course of time, the integrity of the metal of a piece of equipment placed in a hydrogenating environment, from a predefined threshold hydrogen pressure Ps above which there is a risk of hydrogen embrittlement of the said metal, by means of the device as described hereinabove, in which:

a) The said device is placed in the said hydrogenating environment;

b) The said device is used to measure the evolution, over the course of time, of the pressure Pint inside the said chamber of the said device;

c) The said pressure Pint is compared against a maximum acceptable service pressure Pser, the said maximum acceptable service pressure Pser being a function of the said threshold pressure Ps, and, if the said pressure Pint is above the said maximum service pressure Pser, a safeguarding plan for safeguarding the said equipment is implemented.

According to one embodiment of the method according to the invention, the said maximum acceptable service pressure Pser can be expressed as a weighting of the said threshold pressure Ps by a safety factor of between 0.6 and 0.9.

According to one embodiment of the method according to the invention, the said threshold pressure Ps can also be determined by means of at least the following steps: an element made of the said metal is subjected to different hydrogen concentrations and the value of the pressure above which the said element cracks is determined.

According to one embodiment of the method according to the invention, the said hydrogenating environment may comprise water and dissolved H2S, and may have a pH of between 3 and 8 and preferably of between 4 and 7.

According to one embodiment of the method according to the invention, the said hydrogenating environment may be a hydrogen-containing gaseous environment such as is encountered in refinery processes.

### LIST OF THE FIGURES

FIG. 1 is an illustrative depiction of a longitudinal section through one exemplary embodiment of a first alternative form of the device according to the invention.

FIG. 2 is an illustrative depiction of a transverse section through one exemplary embodiment of a second alternative form of the device according to the invention, in which the chamber of the device according to the invention is formed directly in a metal element of a piece of equipment that is to be monitored.

FIG. 3 shows the evolution of pressure over the course of time as measured by means of a device according to the prior art (test C1), of one exemplary embodiment of the device according to the invention (test C2), and of a device which differs from the device according to the invention by use of a material unsuitable for implementing the invention (test C3).

### DESCRIPTION OF THE EMBODIMENTS

The present invention relates to a device for detecting a risk of hydrogen embrittlement of a metal, the device being intended to be placed in a hydrogenating environment. The device may notably make it possible to detect the risk of hydrogen embrittlement of equipment comprising at least one element made from this metal.

Nonlimitingly, the hydrogenating environment may result from the presence of gaseous hydrogen (H2) and/or of hydrogen sulfide (H2S) dissolved in an aqueous phase in an environment the pH of which is between 3 and 8 or else between 4 and 7. Such a hydrogenating environment may be an aqueous environment containing dissolved H2S, as is encountered in petroleum production or in the treatment of biogas derived from the decomposition of organic matter. Such a hydrogenating environment may also be a hydrogen-containing gaseous environment as encountered in petroleum refinery processes.

Nonlimitingly, the equipment the risk of hydrogen embrittlement of which is to be monitored, may be a pipeline, for example a pipeline suited to transporting crude or refined petroleum products.

The equipment the risk of hydrogen embrittlement of which is to be monitored may also be a chemical reactor, such as used in petroleum refinery operations. In particular, the equipment that is to be monitored may be a hydrotreatment reactor.

The device according to the invention relies on measuring the equilibrium pressure (also referred to as the steady-state pressure) in a metallic chamber in order to evaluate the activity of the hydrogen absorbed into the steel. Specifically, by applying Sieverts' law, the activity of a gaseous element dissolved in a metal is directly proportional to the square root of the pressure of that same gas in equilibrium with the metal, which therefore corresponds to the equilibrium pressure (Pe) generated by that gas in the measurement cavity. Therefore, the measurement of the pressure inside the cavity of the sensor can be correlated directly with the activity or concentration of the hydrogen in the steel at equilibrium (Ce). Now, the risk of internal cracking of the “blistering” or “hydrogen induced cracking”, or “HIC” for short, type, is directly linked to the activity of the hydrogen in the steel Measuring the pressure therefore makes it possible to detect directly the risk of hydrogen embrittlement of a metal.

Hereinafter, the hydrogen pressure beyond which embrittlement of the metal of interest occurs will be referred to as the “threshold pressure” and denoted Ps. The hydrogen threshold pressure indicates a threshold concentration of hydrogen dissolved in a metal that is high enough to lead to internal decohesions on a crystallographic scale. It is dependent on the metallographic properties and is therefore a function of the metal itself.

The device according to the invention comprises at least:
a pressure measuring means, such as a pressure sensor for example;
a closed chamber, the chamber being delimited by walls made from the metal the hydrogen embrittlement of which is to be monitored. According to the invention, the chamber further comprises an opening, for communicating with the pressure measuring means. According to one embodiment of the invention, the opening of the chamber may take the form of a hollow tubular body, preferably made from a material capable of withstanding the hydrogenating environment and having sufficient mechanical strength, such as, for example, an austenitic stainless steel or else a nickel alloy. In addition, this opening allows the passage of a connection system for connecting to a pressure sensor;
at least one body formed from a material that is non-porous and inert with respect to hydrogen, placed inside the chamber, the volume of the body/these bodies representing at least 50% of the interior volume of the chamber. For preference, the chamber comprises a plurality of bodies that are non-porous and inert with respect to hydrogen.

The presence, in the chamber, of at least one body formed from a non-porous (and inert) material, these bodies together occupying at least 50% of the interior volume of the chamber, makes it possible to reduce the volume available for the hydrogen in the chamber of the device. In this way, the hydrogen threshold pressure as described hereinabove can be reached more quickly. Specifically, for a given hydrogen flux, the response time of the device, defined as being the time taken to reach the hydrogen threshold pressure, is directly proportional to the volume of the cavity in which the hydrogen accumulates. Thus, the presence of non-porous bodies in the chamber of the device according to the invention makes it possible to improve the response time of the device according to the invention. In addition, this solution offers the advantage of reducing the response time of the device, but of doing so without degrading its inherent mechanical integrity, unlike a solution according to the prior art in which the thickness of the wall of the chamber is reduced. Advantageously, the volume of the body or bodies placed inside the chamber represents at least 75% of the interior volume of the said chamber.

The device also offers a notable advantage over a technical solution whereby the size of the chamber is reduced (for example the outside diameter in the case of a tubular chamber or the external dimensions in general in the case of a chamber of non-tubular geometry). Specifically, it thus avoids precision machining techniques, which are potentially very expensive, particularly for forming the small-sized internal cavity.

Furthermore, the device according to the invention also offers a notable advantage in instances in which the device according to the invention is used in a hydrogenating corrosive environment such as, for example, in an environment containing water and dissolved H₂S. Specifically, in such environments, the penetration of hydrogen into the metal is inseparable from the reaction by which the metal corrodes. In such an environment, the metal chamber suffers a thinning of its walls in pace with its exposure. The present invention, by not requiring a reduction in the thickness of the walls of the chamber, makes it possible to maintain sufficient mechanical strength in service, even in highly corrosive environments.

According to the invention, the material of the non-porous bodies that are placed inside the chamber is also inert with respect to hydrogen, which means to say that the material of the body or bodies is unable to interact chemically and/or physically with the hydrogen. The purpose of this is to prevent all or some of the gaseous hydrogen present in the chamber from being used up by reactions with the body or bodies, thus falsifying the measurement of the pressure in the chamber. According to one embodiment of the invention, bodies made from a material of the ceramic or glass type are chosen, these materials additionally not being porous so as to satisfy the first condition listed hereinabove. In general, metallic materials are avoided, as are polymer materials: specifically, with these types of materials, there is the possibility of interactions with the hydrogen (for example through the formation of hydrides or by permeation into the material of the filling body) potentially falsifying the measurement of the pressure in the chamber. This for example excludes the use, by way of material for the body or bodies placed inside the chamber, of metals such as titanium, which is liable to react with hydrogen to form hydrides.

The geometry of the body or bodies that are non-porous and inert with respect to hydrogen may be any. In the case of a tubular chamber, the bodies that are non-porous and inert with respect to hydrogen may take the shape of one or more rods of a diameter less than that of the chamber of the device according to the invention. In the case of a chamber of more complex geometry, the bodies that are non-porous and inert with respect to hydrogen may be in the form of beads, preferably having different particle sizes so that they can occupy as much as possible of the interior volume of the chamber.

According to one embodiment of the invention, the thickness of the or of each of the metal walls that form the chamber are dimensioned in such a way that the burst pressure of the chamber is strictly higher than the hydrogen threshold pressure. For preference, the thickness of the or of each of the metal walls that form the chamber are dimensioned in such a way that the burst pressure of the chamber is at least twice as high as the hydrogen threshold pressure for the metal in question. In this way, the mechanical integrity of the device according to the invention is guaranteed in service. A specialist is perfectly aware of techniques for determining the burst pressure of a metal chamber, according to the shape thereof. Reference may be made to Barlow's approximated formula for the case of a chamber in the form of a tube, which formula expresses the burst pressure (Pmax) of a metallic tube as a function of the breaking strength (Rm) of the metal, the thickness (l) of the walls, and the outside diameter (D) of the tube, using the formula of the type:

Pmax=2×Rm×l/D. [Math 1]

According to one embodiment of the invention, whereby the device according to the invention is intended to monitor a piece of equipment at least one element of which is made from a metal, the thickness of the thinnest wall of the chamber is between ⅓ and 1/50 of the smallest dimension of the metal element that is to be monitored. In this way, in addition to reducing the volume available inside the chamber, the thickness of the walls of the chamber is also reduced so as to further improve the response time of the device according to the invention. As a preference, the thickness of the thinnest wall of the chamber is between ¼ and 1/10 of the smallest dimension of the metal element.

According to one embodiment of the invention, the device further comprises means for transmitting (for example via an electric wire or optical fibre) the measurements made by means of the said pressure measuring means, and/or means for processing (for example for computer-processing using a microprocessor) the measurements taken by means of the pressure measuring means.

According to one embodiment of the invention, the device may further comprise an alerting means for raising an alert when a pressure higher than a maximum acceptable service pressure is detected in the chamber. This alerting means may for example be a visual or audible indication, which may be positioned in the immediate vicinity of the device, or else remotely on a computerized measurement system of the supervision type. According to the invention, the maximum acceptable service pressure Pser is a function of the hydrogen threshold pressure Ps beyond which embrittlement of the metal in question occurs. According to one embodiment of the invention, the maximum acceptable service pressure Pser corresponds to the threshold pressure Ps weighted by a safety factor c of between 0 and 1, using a formula of the type Pser=Ps·c. Advantageously, the safety factor c is comprised between 0.6 and 0.9. Means for determining the threshold pressure Ps are described hereinafter.

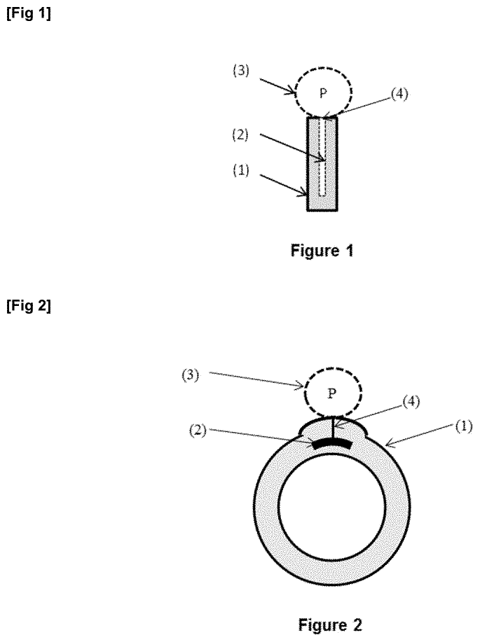

According to a first alternative form of the invention, the device according to the invention is distinct from the equipment that is to be monitored, which means to say that they have no structural element in common. In that case, the metal from which the chamber of the device according to the invention is formed is advantageously representative of the metal of an element of a piece of equipment subjected to a hydrogenating environment the risk of hydrogen embrittlement of which is to be monitored. Specifically, the values of threshold pressure Ps which define the quantity of absorbed hydrogen beyond which the metal is liable to crack, are specific to each metal or to each grade of steel. It is therefore important that the metal used for the chamber of the device be representative of the metal of the equipment that is to be monitored, and, preferably, that it be identical to the metal of the equipment that is to be monitored. According to one embodiment of the invention whereby the metal of interest is steel, the grade of the steel from which the chamber is formed is the same as the grade of the steel from which is formed the metal element of the equipment to be monitored. In this first alternative form of the invention, the device according to the invention is advantageously positioned in the vicinity of the equipment that is to be monitored, so as to be situated in the same hydrogenating environment. In this first alternative form, the metallic chamber may have any shape because it is separate from the equipment that is to be produced. Advantageously, the chamber may have a tubular shape, but the chamber may have any shape, and for example be spherical or parallelepipedal. FIG. 1 shows one exemplary embodiment of this first alternative form of the invention, in which the chamber 2 is formed by walls 1 made of a tube closed at one of its ends, the opposite end of the tube not being closed, so as to form an opening 4 to communicate with a pressure sensor 3.

According to a second alternative form of the invention, the chamber of the device according to the invention is formed in the metal element of the equipment the hydrogen embrittlement risk of which is to be monitored. More specifically, the equipment to be monitored comprises at least one element at least one wall of which is made of metal, and the chamber of the device is made in at least a portion of this wall of the equipment. According to one embodiment of this alternative form of the invention, the chamber may be machined directly into a metallic wall of the equipment that is to be monitored. FIG. 2 shows one exemplary embodiment of this second alternative form, in which the equipment that is to be monitored is a pipeline, for example made of steel, the chamber 2 and therefore its walls 1 being formed actually within a portion of the pipeline that is to be monitored, the chamber 2 communicating with a pressure sensor 3 via an opening 4.

The invention also relates to a method for monitoring, over the course of time, the integrity of the metal of a piece of equipment placed in a hydrogenating environment, from a predefined threshold hydrogen pressure Ps above which there is a risk of hydrogen embrittlement of the said metal.

The method according to the invention is described hereinafter as implemented by means of the device as described hereinabove, but could equally be implemented by means of any device for measuring the pressure resulting from the permeation of hydrogen within the metal of the equipment that is to be monitored.

The method according to the invention comprises at least the following steps:
a) The device according to the invention is placed in the hydrogenating environment;
b) The device according to the invention is used to measure the evolution, over the course of time, of the pressure Pint inside the said chamber of the device;
c) The pressure Pint is compared against a maximum acceptable service pressure Pser, which is a function of the threshold pressure, and, if the pressure Pint is above the maximum acceptable service pressure Pser, a safeguarding plan for safeguarding the equipment is implemented.

According to one embodiment of the invention, the threshold pressure Ps for the metal of interest is determined by means of any hydrogen embrittlement test method well known to those skilled in the art. In general, for this method, an element made from the metal of interest is subjected to various hydrogen concentrations, and the pressure value beyond which the element cracks is determined using a pressure sensor. These tests can be carried out by means of the device according to the invention. Included among these methods for testing for hydrogen embrittlement, mention may be made for example of the test described in document NACE TM0284 (NACE International) which describes how to carry out tests of resistance to HIC of lightly alloyed steels in aqueous environment containing dissolved H2S.

According to one embodiment of the invention, the maximum acceptable service pressure Pser corresponds to the threshold pressure Ps weighted by a safety factor c of between 0 and 1, using a formula of the type: Pser=Ps·c. Advantageously, the safety factor c is comprised between 0.6 and 0.9.

According to one embodiment of the invention, the safeguarding plan for safeguarding the equipment that is to be monitored may involve shutting down the operation of the equipment that is to be monitored, for example by de-pressurizing pressurized equipment and then emptying it of its products, or, in the case of a pipe carrying hydrocarbons, by stopping the flow of products and then carrying out a draining operation.

According to another alternative form, the safeguarding plan for safeguarding the equipment that is to be monitored may involve setting in place measures aimed at reducing the hydrogen load, for example by injecting corrosion inhibitors. The effectiveness of the measures can then be evaluated using the device according to the invention which must then demonstrate that the hydrogen pressure has stabilized or reduced.

The method according to the invention can be implemented by means of an item of equipment (for example a computer workstation) comprising data processing means (a processor), data storage means (a memory, in particular a hard disk), an input/output interface for interacting with a user, and communication means.

The data processing means may be configured in order in particular to perform steps b) and c) of the method according to the invention, in which steps the method determines digitally whether an internal pressure Pint has been reached and compares this equilibrium pressure with a maximum acceptable service pressure Pser.

The communication means may be configured to send an alert to a remotely situated location, when it is found that the internal pressure is higher than the maximum acceptable service pressure.

### EXAMPLES

The advantages of the device and of the method according to the invention are set out hereinafter in a comparative example of an application.

For this example, use is made of a device comprising a tubular chamber made of pure iron, 80 mm in length, 3.2 mm in outside diameter and 1.8 mm in inside diameter. The device further comprises a metal support made of austenitic stainless steel of type AISI 316L connecting the chamber to the pressure sensor. This device is exposed to a hydrogenating and corrosive environment made up of salt water (50 g/l NaCl) saturated with H₂S dissolved at a pressure of 1 bar.

For comparative purposes, three tests were conducted:
1—Test 1: no bodies were introduced into the chamber of the device. This then is a device similar to the prior art. The free volume in the chamber is 3.7 ml
2—Test 2: bodies made of ceramic, more particularly of the alumina type, were introduced into the chamber. This test then corresponds to one exemplary embodiment of the device according to the invention. The geometries of these bodies correspond to portions of a rod of a diameter slightly smaller (smaller by 0.1 to 0.2 mm) than the diameter of the chamber. The free volume in the chamber, taking these additional bodies into consideration, is 0.56 ml, namely more than 6 times smaller than in Test 1.
3—Test 3: bodies made of a polymer material, more specifically of polyethylene, were introduced into the chamber, and in such a way that the free volume in the chamber was the same as the free volume in the case of Test 2, namely around 0.56 ml. This test sought to evaluate the relevance of the material of the bodies placed in the chamber according to the invention.

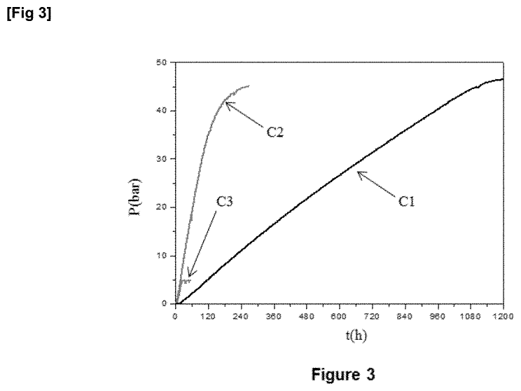

FIG. 3 shows the evolution of the pressure P measured in the chamber as a function of time t, in the case of the three tests described above. Thus, curve C1 shows that, in the case of Test 1, the steady-state hydrogen pressure is between 45 and 50 bar, and is reached after approximately 1200 hours of testing. Curve C2 shows that, in the case of Test 2, a steady-state hydrogen pressure of 45 bar (therefore a level equivalent to that of the first test) is measured, but after a duration of just 200 hours.

And finally, curve C3 shows that, in the case of Test 3, the curve of pressure increase exhibits a behaviour that is less linear than in the other two tests, evolving as a series of step changes. In addition, after a pressure of 5 bar, no further appreciable variation in pressure was observed. After halting this test, it was found that the pressure sensor was damaged, following the application of a contact pressure through contact with a polymer body that had been positioned just beneath the sensor membrane. These results indicate that a swelling reaction occurred between the polymer and the gaseous hydrogen, and that this swelling led to damage to the measurement device. This demonstrates that a polymer material, and notably a polyethylene, which is not a material that is both non-porous and inert with respect to hydrogen, is not suitable for the bodies according to the invention that are to be placed inside the chamber of the device according to the invention.

Thus, the present invention offers a significant advantage over the prior art because it makes it possible to achieve a steady-state pressure in the chamber of the device in a far shorter time, thereby making it possible more quickly to detect a risk of embrittlement of the equipment that is to be monitored. In addition, the choice of the material relating to the bodies placed inside the chamber of the device according to the invention allows pressure to be measured reliably and makes it possible to avoid early damage to the device according to the invention.

1. Device for detecting a risk of hydrogen embrittlement of a metal, the device being intended to be placed in a hydrogenating environment, the device comprising at least:
a pressure measuring means,
a closed chamber, the chamber being delimited by walls formed from the metal, the chamber comprising an opening to communicate with the pressure measuring means
wherein at least one body formed from a material that is non-porous and inert with respect to hydrogen is placed inside the chamber, the volume of the at least one body representing at least 50% of the interior volume of the chamber.

2. Device according to claim 1, wherein the volume of the at least one body represents at least 75% of the interior volume of the chamber.

3. Device according to claim 1, wherein the material of the body is a non-porous ceramic or a non-porous glass.

4. Device according to claim 1, wherein the device further comprises means for transmitting the measurements taken by means of the pressure measuring means and/or means for processing the measurements taken by means of the pressure measuring means.

5. Device according to claim 1, wherein the device further comprises a means for raising an alert when a pressure higher than a maximum acceptable service pressure is measured by means of the pressure measuring means.

6. Device according to claim 1, wherein the walls are made of steel.

7. System comprising at least one piece of equipment and at least one device according to claim 1, the equipment comprising at least one wall made from the metal, the chamber of the device being formed in at least part of the wall in the equipment.

8. System comprising at least one piece of equipment and at least one device according to claim 1, the equipment comprising at least one element formed from the metal, the device being separate from the equipment.

9. System according to claim 7, wherein the equipment is a pipeline.

10. System according to claim 7, wherein the equipment is a chemical reactor.

11. Method for monitoring, over the course of time, the integrity of the metal of a piece of equipment placed in a hydrogenating environment, from a predefined threshold hydrogen pressure Ps above which there is a risk of hydrogen embrittlement of the metal, by means of the device according to claim 1, in which:
a) the device is placed in the hydrogenating environment;
b) the device is used to measure the evolution, over the course of time, of the pressure Pint inside the chamber of the device;
c) the pressure Pint is compared against a maximum acceptable service pressure Pser, the maximum acceptable service pressure Pser being a function of the threshold pressure Ps, and, if the pressure Pint is above the maximum service pressure Pser, a safeguarding plan for safeguarding the equipment is implemented.

12. Method according to claim 11, wherein the maximum acceptable service pressure Pser is expressed as a weighting of the threshold pressure Ps by a safety factor of between 0.6 and 0.9.

13. Method according to claim 11, wherein the threshold pressure Ps is also determined by means of at least the following steps: an element made of the metal is subjected to different hydrogen concentrations and the value of the pressure above which the element cracks is determined.

14. Method according to claim 11, wherein the hydrogenating environment comprises water and dissolved H2S, and has a pH of between 3 and 8 and preferably of between 4 and 7.

15. Method according to claim 11, wherein the hydrogenating environment is a hydrogen-containing gaseous environment such as is encountered in refinery processes.
